(19) United States
(12) Patent Application Publication
(10) Pub. No.: US 2005/0077472 A1
(43) Pub. Date: Apr. 14, 2005

(54) Irradiation system having cybernetic parameter acquisition system

(75) Inventor: Sergey A. Korenev, Mundelein, IL (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: STERIS Inc.

(21) Appl. No.: 10/683,410

(22) Filed: Oct. 10, 2003

(51) Int. Cl. G01F 23/00

(52) U.S. Cl. 250/360.1

(57) ABSTRACT

Irradiation system including a cybernetic parameter acquisition system, for acquiring parameter data associated with an object to be irradiated. The system includes apparatus for measuring doses of electron beams that are absorbed by an object subjected to irradiation. The absorbed dose can be continuously measured during an irradiation process, and adjustment can be made to operating parameters of the irradiation system in accordance with the measured absorbed dose.

### FIELD OF THE INVENTION

The present invention relates to an irradiation system, and more particularly to an irradiation system including a cybernetic parameter acquisition system, for acquiring parameter data associated with an object to be irradiated.

### BACKGROUND OF THE INVENTION

In recent years, there has been an increased need for systems that can destroy biological and chemical warfare agents, including, but not limited to bacteria, anthrax, spores, fungi, and the like. One method for propagating biological and chemical warfare agents is through the use of a mail delivery system (e.g., United States Postal Service, Courier package delivery services, and the like), used for delivery of articles such as envelopes and packages. Accordingly, there is a need for systems that “sanitize” such articles by deactivation of any biological and/or chemical warfare agents contained therein.

Known techniques for deactivation of biological and chemical warfare agents, include, but are not limited to: (a) radiation treatment methods using an electron beam (e-beam), an x-ray beam, a gamma ray beam, a photon beam (isotope source), and ultraviolet (UV) light; (b) plasma treatment methods for etching with a glow discharge; and (c) gas treatment methods, such as ozone gas. Each of these techniques has its own drawbacks, especially for sanitization of articles such as envelopes and packages.

Plasma treatment methods destroy biological and chemical agents by exposing the articles to high temperatures, exceeding 3000° C. Unfortunately, such high temperatures will also lead to destruction of the article being treated. With gas treatment methods, it is difficult for the gas to penetrate the article to expose the warfare agents to the treatment gas. Moreover, some gases, such as ozone, quickly degrade, making it difficult to effectively treat the article. Treatment with radiation results in significant heat production. Consequently, the temperature of the warfare agent and the article increases. As a result, there is an increased probability that a biological warfare agent may mutate to other forms, and that the article may become damaged and break open, dispersing the biological agent. In order to minimize heat production during a radiation treatment process, there is a need to closely monitor the level of “absorbed dose” for the article being treated. Absorbed dose refers to the energy imparted by ionizing radiation per unit mass of an irradiated material, and is commonly defined in units of J/kg, Grays, or Rads.

The present invention provides an irradiation system that uses a radiation treatment process to deactivate biological and chemical warfare agents that may be concealed in articles, such as envelopes and packages.

### SUMMARY OF THE INVENTION

In accordance with the present invention, there is provided an irradiation apparatus, comprising: (a) a parameter acquisition system for acquiring physical parameter data associated with an object to be irradiated; (b) an irradiation source for providing a beam, said beam selected from the group consisting of: e-beam and an X-ray beam; (c) a conveyor system for conveying an object to be irradiated through the radiation beam at a speed v, said conveyor system including an opening that allows a portion of the beam to pass through the object without striking the conveyor system; and (d) an absorbed dose sensing apparatus for providing data for determining an absorbed dose associated with the object.

In accordance with another aspect of the present invention, there is provided a method for irradiating an object, comprising the steps of: (a) acquiring physical parameter data associated with an object to be irradiated; (b) generating a beam, said beam selected from the group consisting of an e-beam and an X-ray beam; (c) moving an object through the beam on a conveyor system, said object traveling at a speed v; and (d) determining an absorbed dose D associated with the object.

In accordance with yet another aspect of the present invention, there is provided an irradiation system, comprising: (a) radiation generating means for generating a beam of known energy; (b) conveyance means for conveying an object through said beam at a speed v; (c) sensing means for providing data indicative of a kinetic energy absorbed by the object; and (d) processing means for receiving said data and determining a value for absorbed dose D of the object.

It is an advantage of the present invention is to provide a system for irradiation that acquires object parameters to determine an optimum radiation treatment for an object.

Another advantage of the present invention is to provide a system for irradiation that acquires object parameters to determine operating parameters of the irradiation system for irradiation of an object.

Another advantage of the present invention is to provide a system for irradiation that synchronizes irradiation processing steps with the position of an object relative to a radiation source.

Still another advantage of the present invention is to provide a system for irradiation that can easily and safely treat typical articles that are processed through a mail delivery system, including, but not limited to envelopes and packages.

Still another advantage of the present invention is to provide a system for irradiation that uses a combination of radiation, thermal and shock waves (ballistic) effects to deactivate biological warfare agents (e.g., bacteria, spores and fungi).

It is still another advantage of the present invention is to provide a system for irradiation that uses a combination of an electron beam acting as an oxide, and thermal effects, to deactivate chemical warfare agents.

It is still another advantage of the present invention to provide a system for irradiation that accurately measures the “absorbed dose” of electron beams that are absorbed by an object subject to irradiation.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1A is a side view of an irradiation apparatus according to a preferred embodiment of the present invention, said irradiation apparatus including a cybernetic parameter acquisition system and an apparatus for determining an absorbed dose;

FIG. 1B is a perspective view of the irradiation apparatus shown in FIG. 1A;

FIG. 2 is a side view partially in section of the system shown in FIG. 1B;

FIG. 3 is a cross-sectional view taken along line 3-3 of FIG. 2, showing a collimator and first and second sensors of the apparatus for determining an absorbed dose, according to a preferred embodiment of the present invention;

FIG. 4 is a partially sectioned, perspective view of the collimator shown in FIGS. 2 and 3;

FIG. 5 is a cross-sectional view taken along line 5-5 of FIG. 4, showing the collimator and the first sensor;

FIG. 6 is a cross-sectional view taken along line 6-6 of FIG. 4, showing the collimator and the second sensor;

FIG. 7 is a graph showing the dependency between a factor of absorption (I2/I1) and kinetic energy of electrons, for an aluminum foil absorber plate;

FIG. 8 is a graph showing the dependency between a factor of absorption (I2/I1) and kinetic energy of electrons, for a copper foil absorber plate;

FIG. 9A is a block diagram illustrating the data inputs to a processing system for processing data to determine absorbed doses of an electron beam;

FIG. 9B is a block diagram illustrating an exemplary software algorithm used by the processing system to determine an absorbed dose;

FIG. 10 is a graph illustrating a typical absorbed dose distribution for one-sided irradiation of an object;

FIG. 11 is a graph illustrating the correlation between kinetic energy of electrons and optimal thickness of objects having a density of 1.5 g/cm3, for one-sided irradiation;

FIG. 12 is a graph illustrating a typical absorbed dose distribution for two-sided irradiation of an object;

FIG. 13 is a flow diagram illustrating an operation control algorithm;

FIG. 14 is a sectional view of a collimator, and a second sensor according to an alternative embodiment; and

FIG. 15 is sectional view illustrating a collimator according to an alternative embodiment.

### DETAILED DESCRIPTION OF A PREFERRED EMBODIMENT

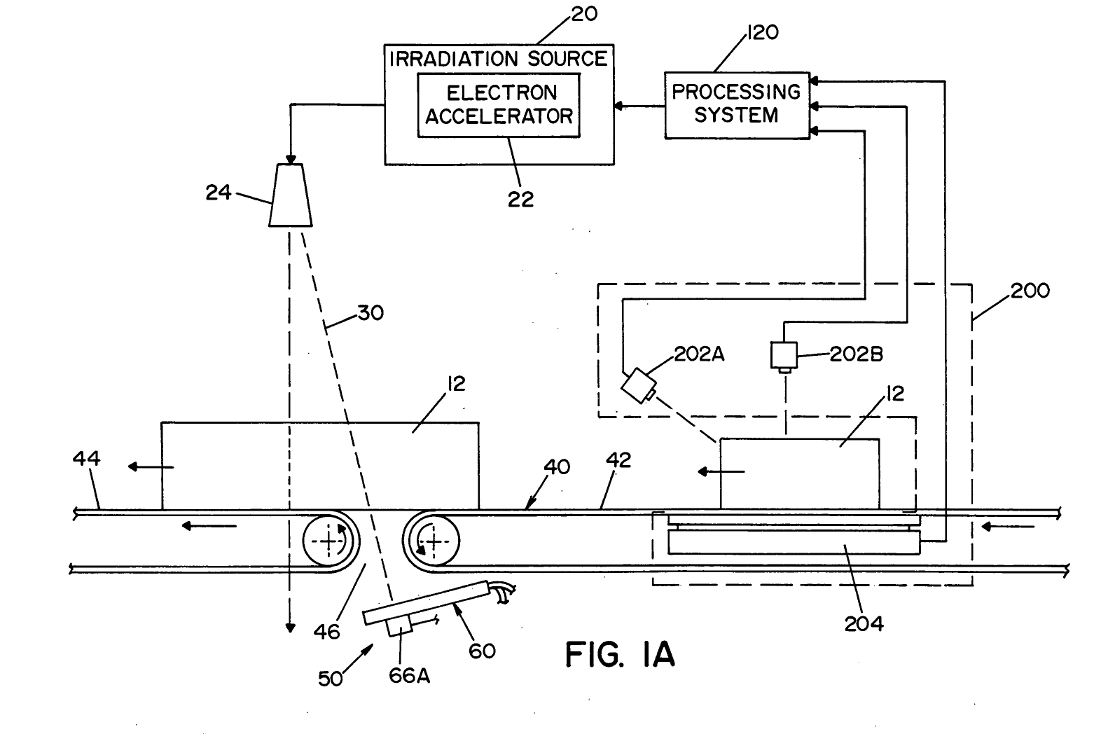

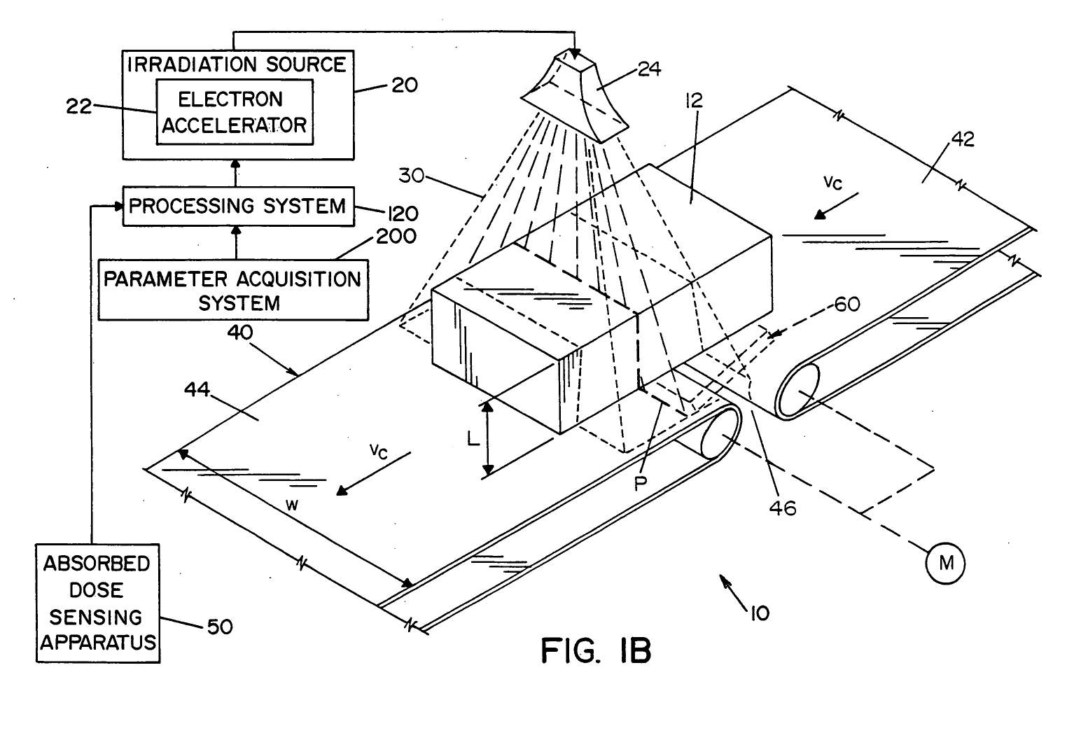

Referring now to the drawings wherein the showings are for the purpose of illustrating the preferred embodiment of the invention only, and not for the purpose of limiting same, FIGS. 1A and 1B show an irradiation system 10, according to a preferred embodiment of the present invention. Irradiation system 10 includes an irradiation source 20, a conveyor system 40, an absorbed dose sensing apparatus 50, a processing system 120, and a cybernetic parameter acquisition system 200.

Parameter acquisition system 200 acquires object parameters associated with an object 12 that is to be irradiated. It should be understood that object 12 may take the form of articles that are processed through a mail delivery system, including, but not limited to envelopes and packages. Object parameters include, but are not limited to: geometric dimensions of the object (e.g., thickness, width, length and cross-section dimensions) and average density. One or more of the object parameters are used to determine operating parameters of irradiation system 10. In a preferred embodiment, parameter acquisition system 200 includes one or more imaging units 202A, 202B and a pressure sensor 204. Imaging units 202A, 202B are used to acquire geometric dimensions of object 12, while pressure sensor 204 is used to determine the weight/mass of object 12 and thereby acquire the average density (mass per unit volume) of object 12.

Irradiation source 20 includes a source of electrons and an electron accelerator 22 for producing an electron beam (e-beam) 30. In a preferred embodiment, electron accelerator 22 is operated in a pulsed mode with a power of about 200-500 kW. The output of irradiation source 20 is an output beam selected from electron beam 30 and an X-ray beam (i.e., photon beam). An e-beam is the preferred beam for objects having a relatively small thickness (e.g., envelopes), and an X-ray beam is the preferred beam for thicker objects, such as boxes. It should be appreciated that X-ray beams allow the conveyer speed (throughput) to be increased because the depth of penetration of X-rays is greater than the depth of penetration of electrons of an e-beam. However, for X-ray beams, the kinetic energy of electrons and the power of electron accelerator 22 must be increased, because the “factor of conversion” for electron beam to X-ray beam is about 5-7% for a 5 MeV electron beam and a tantalum (Ta) target plate. The factor of conversion is a value of the number of X-rays (bremsstrahlung) to the number of electrons, as well known to those skilled in the art.

Irradiation source 20 produces an X-ray beam when an e-beam is incident on a metal target plate (e.g., tantalum, gold, tungsten or copper). The output beam of irradiation source 20 irradiates an object, while conveyor system 40 moves the object through the output beam. It should be appreciated that a preferred embodiment of the present invention will be described herein with reference to an output beam in the form of an electron beam 30. However, as indicated above, the output beam may also be selected to be in the form of an X-ray beam.

Electron accelerator 22 accelerates electrons to form e-beam 30 having a preselected energy and beam current. E-beam 30 is output through a horn 24, as best seen in FIGS. 1A and 1B. The preselected energy values of e-beam 30 are typically in the range of 0.2 MeV to 20 MeV, and preferably about 1 MeV to 10 MeV. As indicated above, electron accelerator 22 preferably operates in a pulsed mode to produce a pulsed e-beam. Examples of suitable electron accelerators include, but are not limited to, Rhodotron™ and Dynamitron™ electron accelerators, manufactured by IBA (Belgium). The beam current of e-beam 30 will depend upon the type of electron accelerator used. Beam currents may range from 1 mA to 1 MA, depending upon the accelerator type. In the case of a pulsed electron accelerator, the beam current will typically be in the range of 1 A to 106 A. In a preferred embodiment, the distance between horn 24 and conveyor system 40 is about 70 to 80 cm.

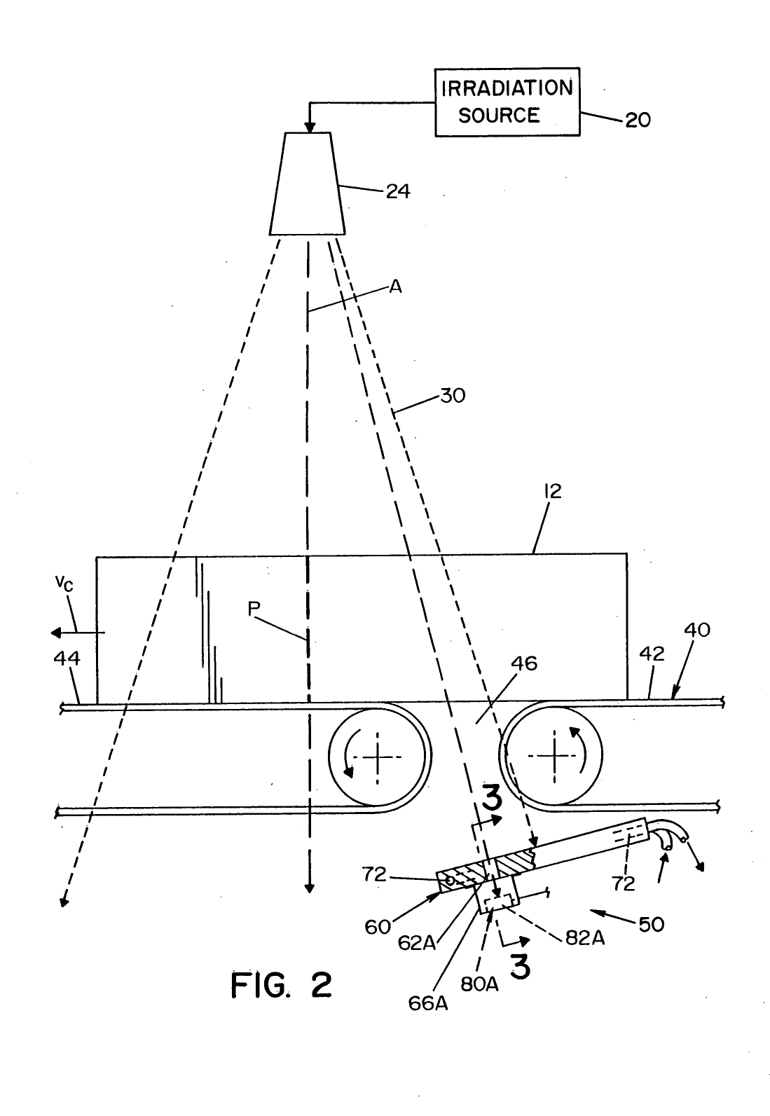

Irradiation source 20 may also include a scanning control (not shown) to scan e-beam 30 back and forth in a selected plane across conveyor 40 at a repetition frequency (e.g., 100 Hz). Horn 24 focuses e-beam 30 towards conveyor system 40. As e-beam 30 leaves horn 24, e-beam 30 consists of a 1-6 cm diameter ray. E-beam 30 expands outwardly the farther the beam extends from horn 24. In other words, the diameter of e-beam 30 increases in air as the distance from horn 24 increases, wherein e-beam 30 assumes a conical shape that is symmetrical about a central beam axis “A,” as best seen in FIG. 2. This conical shape results from a complex interaction of the electrons from e-beam 30 with a plasma generated in the air.

As will be appreciated by those skilled in the art, the current density of e-beam 30 decreases, as the cross-section of e-beam 30 increases. The cross-section of e-beam 30 is a function of the distance between electron accelerator 22 and the output window (now shown) for electrons, and the distance between the output window for electrons and the object exposed to e-beam 30.

E-beam 30 is rapidly scanned back and forth along scanning path P (see FIG. 1B), in a direction perpendicular to the direction of travel of object 12 (reference arrow vc indicating the direction of travel of object 12). E-beam 30 scanning may be performed in a plurality of modes, namely (1) perpendicular, (2) parallel, or (3) any angle in between, relative to the direction of the moving object (i.e. direction of conveyance). In a preferred embodiment the scanning angle is an arc of about 15° to either side of the center of conveyor 40 (i.e., a total arc of about 30°). It should be appreciated that the dimensions of e-beam 30 are not shown to scale, but are shown solely to illustrate a preferred embodiment of the present invention.

It should be understood that e-beam 30 can be swept in other dimensions. For example, the beam can also be swept parallel to the direction of motion of conveyor system 40, or in two directions, to travel a large rectangular swath. It is contemplated that the present invention is adaptable to these alternative scanning paths as would be readily appreciated by one of ordinary skill in the art.

In the illustrated embodiment, absorbed dose sensing apparatus 50 is configured for use with e-beams. It should be appreciated that absorbed dose sensing apparatus 50 may be configured for use with X-ray beams. A calorimetric sensor is the preferred sensing device for sensing absorbed dose of X-ray beams (i.e., photons). The dissipation of energy of X-rays in a calorimetric sensor results in an increased temperature of the calorimetric sensor. The absorbed dose associated with the X-ray beam is determined by measuring the temperature change of the cabrimetric sensor. The absorbed Joule energy is inferred from the measured temperature change.

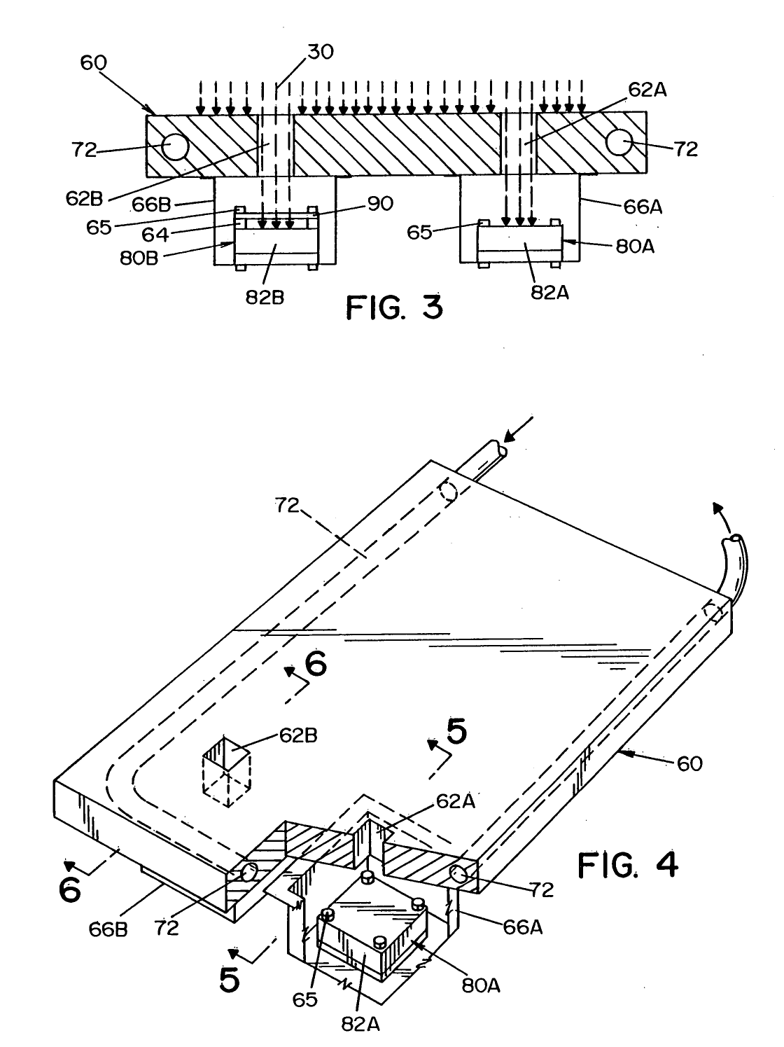

Absorbed dose sensing apparatus 50 includes a collimator 60, and first and second sensors 80A, 80B (see FIG. 3). Collimator 60 isolates portions of e-beam 30 that have passed through object 12. The isolated portions are received by sensors 80A, and 80B. Sensors 80A and 80B are used to provide an indication of the kinetic energy (KE) of the electrons of the e-beam after the e-beam has passed through object 12. Based upon data provided by sensors 80A, 80B and other parameter data, processing system 120 determines a value for “absorbed dose,” as will be explained in detail below. It should be appreciated that absorbed dose sensing apparatus 50 may take forms other than those illustrated herein.

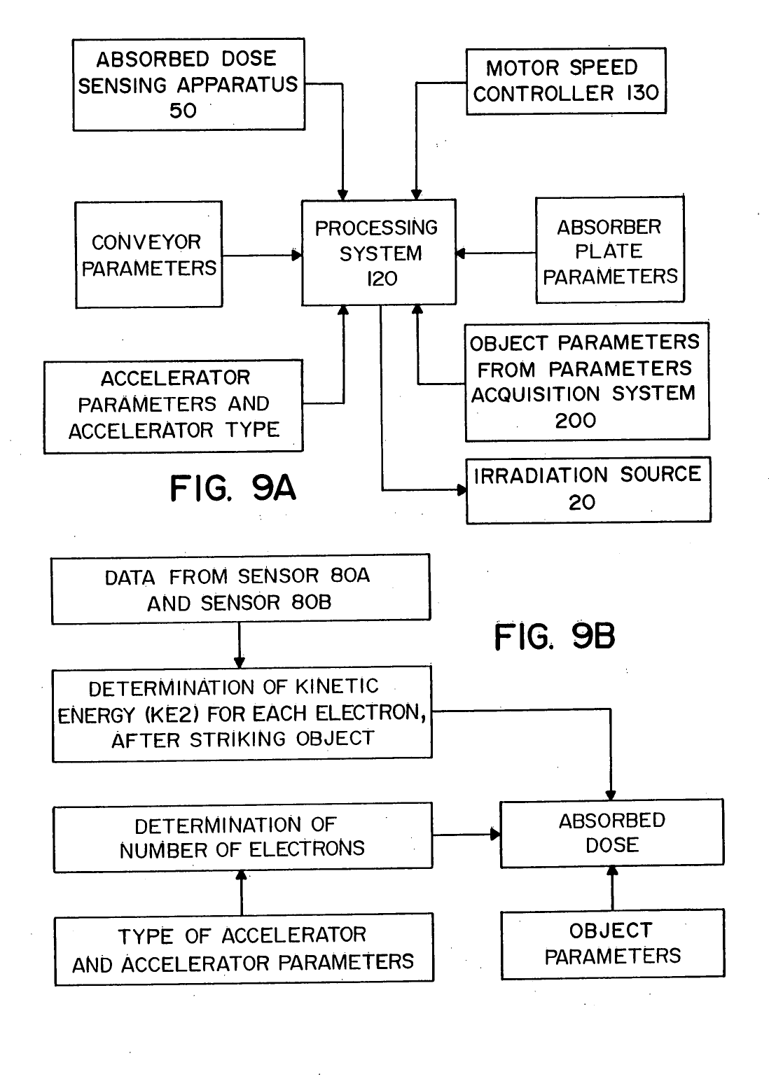

Conveyor system 40 conveys object 12 through e-beam 30. In a preferred embodiment, conveyor system 40 includes first and second belt conveyors 42 and 44. Belt conveyors 42, 44 preferably have a width “w” in a range of 80 to 100 cm. A gap 46 is provided between belt conveyors 42, 44 to provide an open path for e-beam 30 passing through object 12 to reach sensors 80A, 80B, which are described in detail below. In a preferred embodiment, gap 46 is about 1 to 10 cm wide, preferably 4 to 7 cm wide, and more preferably 5 to 6 cm wide. Each belt conveyor 42, 44 is driven by one or more motors M, as schematically illustrated in FIG. 1B. A motor speed controller 130 (see FIG. 9A) controls the speed of the conveyor motors M, and in turn, the speed at which object 12 passes through e-beam 30. In a preferred embodiment, object 12 is conveyed through e-beam 30 by conveyor system 40 at a speed in the range of 0.1 to 50 cm/sec, preferably 0.1 to 35 cm/sec, and more preferably 1 to 15 cm/s.

It should be appreciated that conveyor system 40 is shown solely for the purpose of illustrating a preferred embodiment, and not for limiting same. In this regard, conveyor system 40 may take other forms, including but not limited to an overhead conveyor, a pneumatic conveyor, a hydraulic conveyor, or the like.

Referring now to FIGS. 2-4, collimator 60 is located on the side of belt conveyors 42, 44 opposite irradiation source 20. Collimator 60 is preferably a generally planar structure. In the embodiment shown, collimator 60 is a metal plate having first and second apertures 62A and 62B formed therein. Collimator 60 is positioned relative to the axis of e-beam 30 so as not to be in line with the high intensity portion of e-beam 30.

Apertures 62A, 62B may take any suitable geometric form (e.g., square, rectangle, circle, etc.). In a preferred embodiment, each aperture 62A, 62B is a square opening having a width and length of about 1 cm. Apertures 62A and 62B are dimensioned and aligned with gap 46 so as to receive “like” portions of e-beam 30 passing through object 12 and gap 46. It should be appreciated that in a preferred embodiment, the portions of e-beam 30 that are isolated by apertures 62A, 62B are not those portions of e-beam 30 along axis A. In this regard, the portion of e-beam 30 along axis A has high intensity electrons, and thus generates significant heat. Isolation of portions of e-beam 30 away from axis A minimizes heating of sensors 80A, 80B.

Collimator 60 is also equipped with a cooling system to cool collimator 60. In this regard, collimator 60 is subject to heating caused by e-beam 30 striking collimator 60, as will be explained further below. In a preferred embodiment, the cooling system comprises cooling tubes 72 that circulate a coolant (e.g., water) to effect cooling of collimator 60, as best seen in FIG. 4.

It should be appreciated that collimator 60 has sufficient thickness to function as a radiation shield, thus protecting the components of sensors 80A, 80B and associated cables from the effects of radiation. Accordingly, sensors 80A, 80B and associated cables can be used for long periods of time without degradation due to radiation exposure. In a preferred embodiment, collimator 60 is dimensioned such that sensors 80A, 80B and associated cables receive an absorbed dose D of about zero.

Housings 66A and 66B (FIG. 3) are provided to secure sensors 80A and 80B to collimator 60. In this regard, sensors 80A, 80B are respectively positioned to receive the like portions of e-beam 30 passing through apertures 62A and 62B, as will be described more fully below. Sensors 80A and 80B are respectively secured to housings 66A and 66B by fasteners 65 (e.g., bolts) made of a dielectric material.

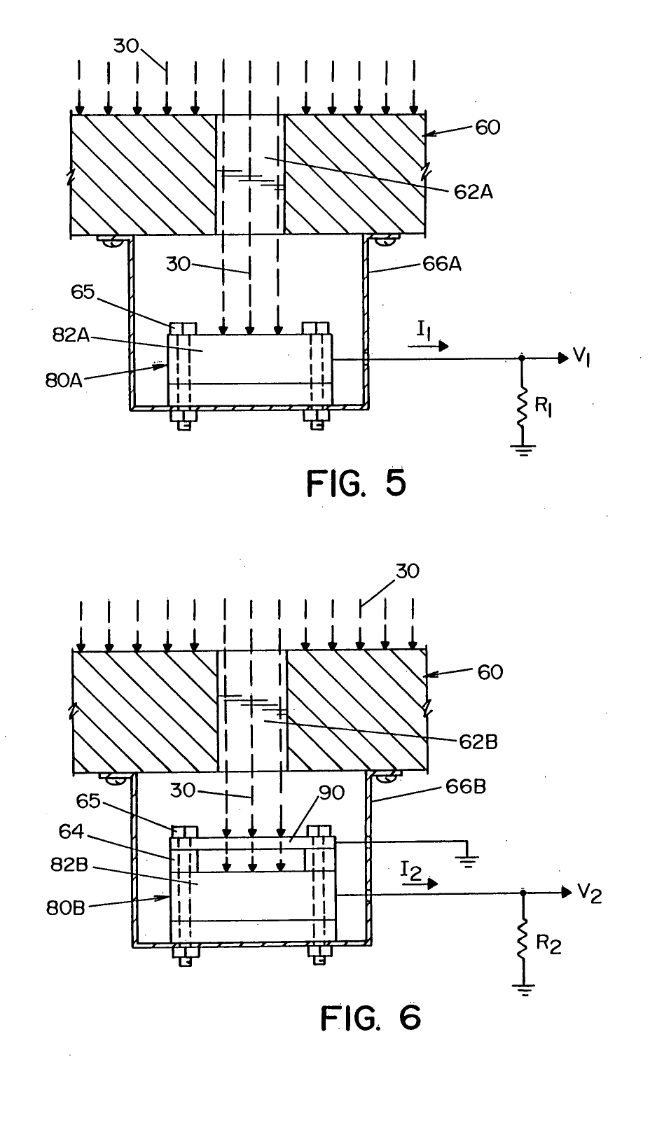

With reference to FIG. 5, in a preferred embodiment, sensor 80A is generally comprised of an electron collecting device in the form of Faraday cup 82A. Sensor 80A is positioned to receive a portion of e-beam 30, that has been isolated by aperture 62A, subsequent to passing through object 12 and gap 46. As will be readily appreciated by those skilled in the art, a Faraday cup is an electron collecting device suitable for measuring current. The current I1 associated with the electrons collected by Faraday cup 82A is determined by measuring voltage V1 across resistor R1 (see FIG. 5). Current I1 is the current associated with the portion of e-beam 30 passing through aperture 62A.

With reference to FIG. 6, in a preferred embodiment sensor 80B is generally comprised of an electron collecting device in the form of Faraday cup 82B, and an absorber plate 90. A ring 64 separates absorber plate 90 from Faraday cup 82B. Ring 64 is preferably made of a dielectric material. Absorber plate 90 is positioned in line with that portion of e-beam 30 that has been isolated by aperture 62B, subsequent to passing through object 12 and gap 46. Faraday cup 82B is positioned to receive e-beam 30 after it has passed through absorber plate 90. The current 12 associated with the electrons collected by Faraday cup 82B is determined by measuring voltage V2 across resistor R2. Current 12 is the current associated with the portion of e-beam 30 after it has passed through object 12 gap 46, aperture 62B, and absorber plate 90.

It should be appreciated that sensors 80A and 80B operate in air, at standard pressure, rather than in a vacuum. Consequently, the air molecules have a small effect on the flux of e-beam 30. In this regard, the air molecules diminish e-beam flux.

In a preferred embodiment, absorber plate 90 is connected to ground. Empirical data determined for absorber plate 90 is used to determine the kinetic energy (KE2) of the electrons after passing through object 12. In this regard, empirical data are determined for absorber plate 90 which relate the ratio of I2/I1 to the kinetic energy of e-beam 30, where 12 is the e-beam current after striking absorber plate 90, and I1 is the e-beam current before the e-beam strikes absorber plate 90. These empirical data are preferably pre-stored in a storage device of processing system 120. As indicate above, the value for 12 is determined from V2 using Faraday cup 82B, while the value for I1 is determined from V1 using Faraday cup 82A.

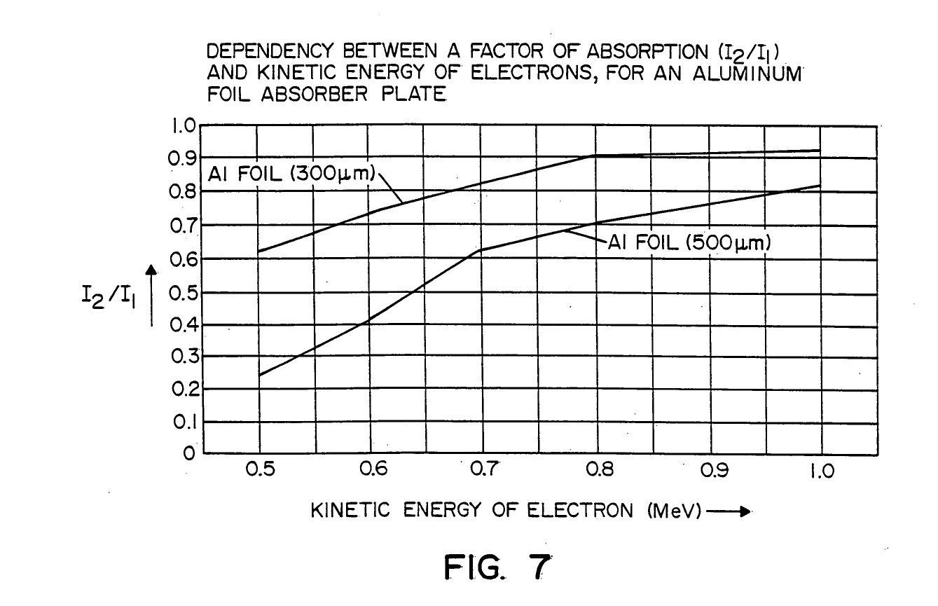

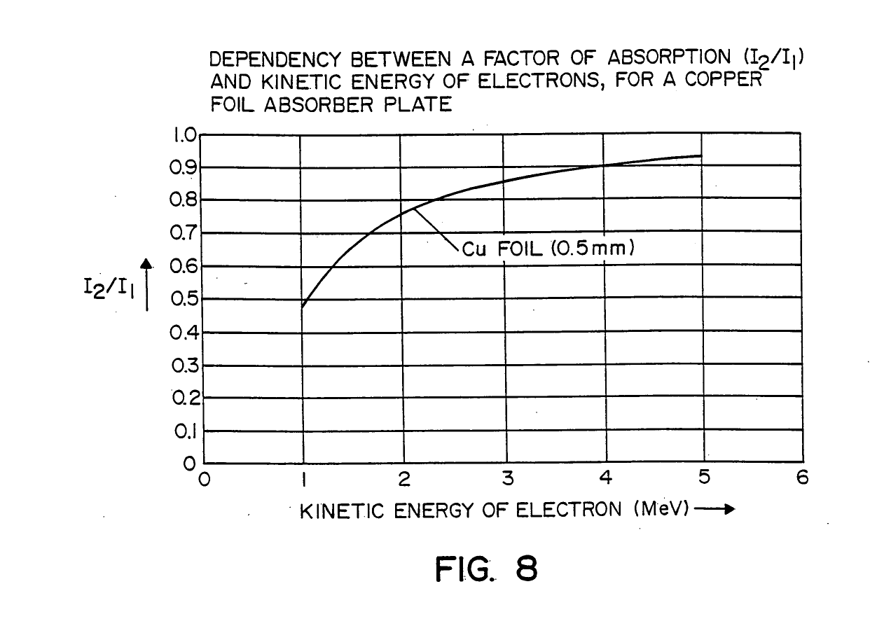

Referring now to FIGS. 7 and 8, there is shown a graph of empirical data for exemplary absorber plates 90. In FIG. 7, the relationship between I2/I1 to kinetic energy (MeV) is shown for an aluminum foil having a density of 2.7 g/cm3 and a thickness of 300 μm, and an aluminum foil having a density of 2.7 g/cm3 and a thickness of 500 μm. In FIG. 8, the same relationship is shown for a copper foil having a density of 8.9 g/cm3 and a thickness of 0.5 mm.

A positioning system (not shown) is used to adjust the position of collimator 60 relative to central axis A and the path thereof. Collimator 60 is positioned to align apertures 62A and 62B with electrons passing through gap 46.

Operating parameters of irradiation system 10 are determined in accordance with the object parameters acquired by parameter acquisition system 200, and the required “absorbed dose” to properly deactivate the warfare agent(s). The operating parameters of irradiation system 10 include, but are not limited to, output beam of irradiation source 20 (i.e., e-beam or X-ray beam), kinetic energy (KE) of electron accelerator 22, beam current, pulse frequency, dimension of the cross-section of the beam output by irradiation source 20, and conveyer speed of conveyer system 40. For instance, KE of electron accelerator 22 is determined in accordance with the thickness of object 12 being irradiated, while the dimension of the cross-section of the output beam is determined in accordance with the cross-sectional dimension of the object. Beam current and number of pulses are determined in accordance with the required absorbed dose, as well as the thermal (temperature) and hydrodynamic (shock wave) conditions for deactivation of warfare agents.

Operation of irradiation system 10 can be summarized as follows. An object 12 (e.g., a package) is subject to physical analysis by parameter acquisition system 200. Irradiation system 10 is then configured with the operating parameters of irradiation system 10 determined in accordance with the acquired object parameters, and the “absorbed dose” value necessary for proper successful deactivation of warfare agent(s). Object 12 is then moved through e-beam 30 by conveyor system 40. Conveyor system 40 is operable to move object 12 at a constant known velocity. As object 12 moves across gap 46 between belt conveyors 42 and 44, it intersects e-beam 30 as e-beam 30 repeatedly scans back and forth across belt conveyors 42 and 44.

Absorbed dose sensing apparatus 50 operates in the following manner to determine a measured “absorbed dose” for object 12. The kinetic energy of e-beam 30, before it strikes object 12 is known. The energy may be established by an energy parameter of e-beam accelerator 22, or by a calibration (sensing) device inserted into e-beam 30. Sensors 80A and 80B are used to determine the kinetic energy absorbed by object 12 during exposure to e-beam 30, as explained in detail below.

It should be appreciated that apertures 62A and 62B isolate “like” portions of e-beam 30 that have previously passed through object 12 and gap 46, to provide like “collimated” e-beams. The portion of e-beam 30 isolated by aperture 62A is received by Faraday Cup 82A of sensor 80A. Similarly, the portion of e-beam 30 isolated by aperture 62B is passed through absorber plate 90, and then received by Faraday Cup 82B of sensor 80B. Accordingly, Faraday Cup 82A is used to determine a current associated with the collimated e-beam before passing through absorber plate 90, while Faraday Cup 82B is used to determine a current associated with the collimated e-beam after passing through absorber plate 90.

As indicated above, collimator 60 shields sensors 80A and 80B, and associated cables for electrical contacts from radiation exposure. In this regard, e-beams not passing through apertures 62A and 62B do not influence measurements provided by sensors 80A and 80B, and do not heat sensors 80A and 80B.

With reference to FIG. 9A, a processing system 120 receives data from absorbed dose sensing apparatus 50 (including sensors 80A and 80B), and using other data (i.e., absorber plate parameters, e-beam accelerator parameters, accelerator type, object parameters, and conveyor parameters), determines a value for “absorbed dose” D associated with object 12. In a preferred embodiment, processing system 120 takes the form of a conventional personal computer (PC) system, including a processing unit, memory storage devices (e.g., RAM, ROM, hard disk drive, floppy disk drive, and CD-RW), an input unit (e.g., keyboard and mouse), and a data output unit (e.g., monitor and printer).

FIG. 9B provides an overview of an algorithm executed by processing system 120 to determine an absorbed dose. Data from sensors 80A and 80B are used to determine the kinetic energy (KE2) for each electron, after striking object 12. In this regard, measured voltages V1 and V2 respectively associated with sensors 80A and 80B are used to calculate values for I1 and I2. The ratio of I2 to I1 is then used to determine a value for kinetic energy KE2 in accordance with the empirically derived relationship illustrated by FIGS. 7 and 8. A more detailed description of the derivation of kinetic energy KE2 is provided below.

Based upon data for the type of accelerator used and other accelerator parameters (e.g., the beam current I of e-beam 30), the number of electrons can be computed for any desired time period. A calculation of an absorbed dose can then be made based upon kinetic energy KE2, the computed number of electrons, the irradiated object parameters (e.g. mass of the object), and the kinetic energy (KE1) of the electrons, as provided by the accelerator.

In this regard, the absorbed dose D associated with an object 12 moving through electron beam 30 is determined in accordance with the following equation:

$$\begin{matrix}D = \frac{( KE1 - KE2 ) ( I ) ( T )}{m} \\ = \frac{\begin{matrix}( Δ KE ) ( no . of coulombs ) \\ ( 6.24 \times {10}^{18} electrons per coulomb ) ( 1.602 \times {10}^{- 19} J / eV )\end{matrix}}{m}\end{matrix}$$

where D is the absorbed dose,
KE1 is the kinetic energy of the electrons before passing through object 12,
KE2 is the kinetic energy of the electrons after passing through object 12,
I is the e-beam current of e-beam 30, as supplied by irradiation source 20, m is a unit mass of irradiated object 12 (the term “unit mass” referring herein to a mass of object 12 corresponding to a preselected area of object 12, and is determined from the object parameters acquired by parameter acquisition system 200), and
T is the total beam exposure time of unit mass m to e-beam 30 (i.e., time of irradiation of unit mass m).

A first step in determining “absorbed dose” D is to determine the change in kinetic energy (ΔKE) of an electron passing through object 12. The initial kinetic energy (KE1) of the electrons (i.e., the kinetic energy of the electrons before passing through object 12) is obtained from the energy parameter of the accelerator that accelerates the electrons, or alternatively, using a sensing device for calibrating and verifying the kinetic energy (KE1) of the electrons exiting horn 24.

In accordance with a preferred embodiment of the present invention, the kinetic energy (KE2) of the electrons after passing through object 12 is determined empirically. As will be appreciated by one of ordinary skill in the art, based upon known absorption characteristics of an absorber material (e.g. a metal foil) a relationship can be derived between an electron beam current (I1) before an e-beam strikes the absorber material, an electron beam current (I2) after the e-beam strikes the absorber material, and the kinetic energy of the electrons of the e-beam. More specifically, the kinetic energy of the electrons can be empirically derived from the ratio of I2 to I1. The absorption characteristics are influenced by the thickness, density, and mass of the absorber material. Examples of this empirically derived relationship are respectively illustrated in FIGS. 7 and 8 for aluminum foil and copper foil absorbers.

In accordance with a preferred embodiment of the present invention, lookup tables of absorbed dose values are pre-stored in processing system 120. The calculated absorbed dose is compared with the pre-stored absorbed dose values. The processing system may be pre-programmed to take one or more actions in response to the result of the comparison. For instance, one or more operating parameters of irradiation system 10 (including but not limited to, conveyor speed, e-beam current, e-beam energy, beam scan velocity, and the like) may be modified to insure that a sufficient dose of electron beam irradiation is absorbed by object 12. In addition, processing system 120 may provide a human-readable data display using a data output unit, and store archival data in memory.

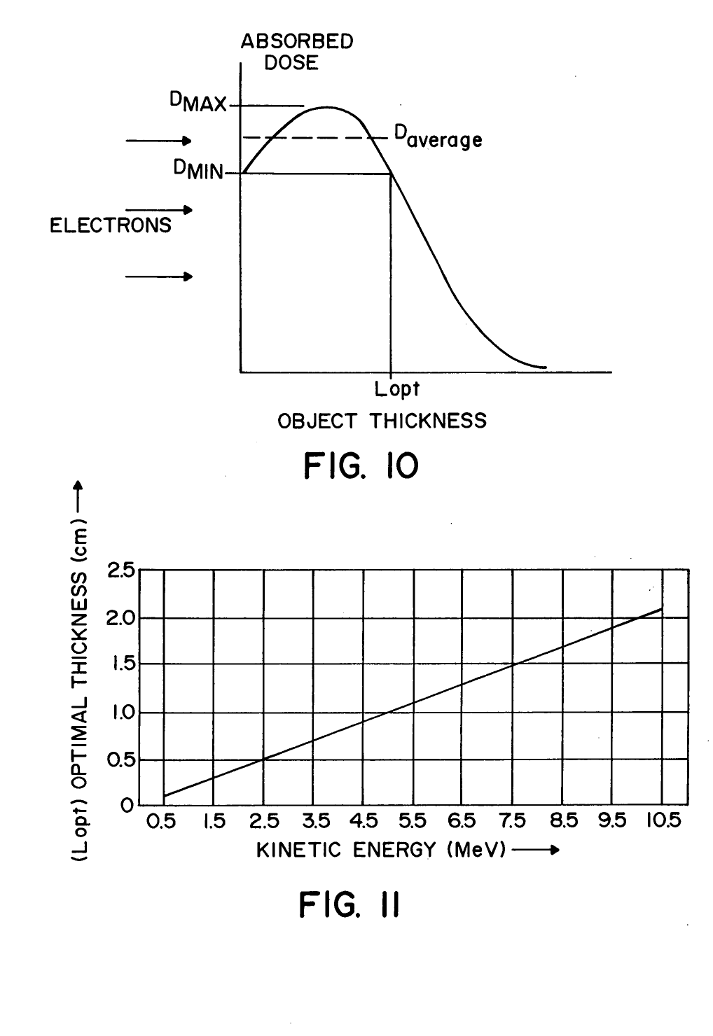

It will be appreciated that it is desirable to have a homogeneous distribution of absorbed dose in the irradiated product. In FIG. 10, there is shown a typical distribution of absorbed dose in an irradiated object for one-sided irradiation. One-sided irradiation refers to an irradiation process wherein the object is subject to radiation incident to only one side of the object. Likewise, two-sided irradiation refers to an irradiation process wherein the object is subject to radiation incident to two sides (i.e., opposite sides) of the object. The distribution of absorbed doses preferably varies by approximately 20%. Average dose (Dₐᵥₑ) is determined by the following expression:
Dₐᵥₑ=[Dₘₐₓ+Dₘᵢₙ]/2,
where Dₘₐₓ is the maximum absorbed dose, and

Dₘᵢₙ is the minimum abosorbed dose.

The optimal thickness (Lₒₚₜ) of an irradiated object is determined from the distribution shown in FIG. 10. By selecting Lₒₚₜ as indicated in FIG. 10, a generally homogenous distribution of absorbed dose is obtained throughout the irradiated object.

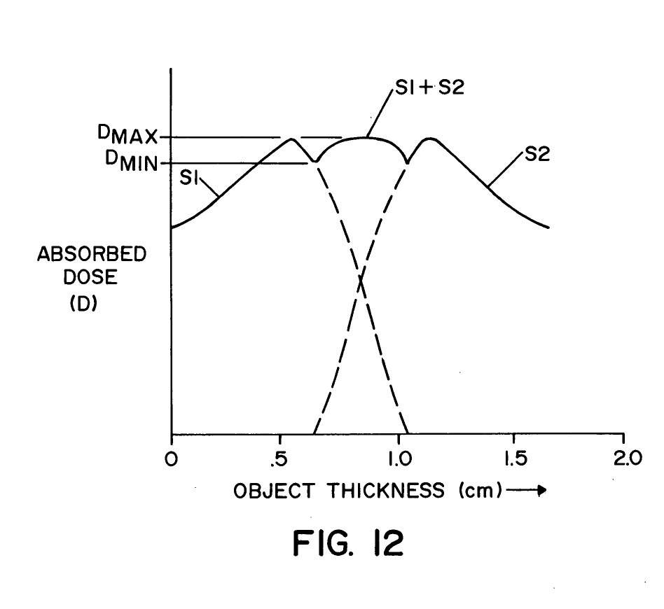

Referring now to FIG. 11, there is shown a correlation between kinetic energy of electrons and optimal thickness of an irradiated object with a density of 1.5 g/cm3, for a one-sided irradiation. The correlation shown in FIG. 11 can be used to determine the appropriate kinetic energy for the electron beam for irradiated objects comprised of typical materials. An empirical formula for determination of optimal thickness (Lopt) for one-sided irradiation is as follows:
Lₒₚₜ=(0.3)(KE)/ρ,
where Lₒₚₜ is in cm, KE is in MeV, and ρ (density of the irradiated object) is in g/cm³. An empirical formula for determination of optimal thickness (Lₒₚₜ) for two-sided irradiation is as follows:
Lₒₚₜ=(0.8)(KE)/ρ,
where Lₒₚₜ is in cm, KE is in MeV, and ρ (density of irradiated object) is in g/cm³. FIG. 12 shows a graph of absorbed dose distribution for a two-sided irradiation process, including first side S1 and second side S2.

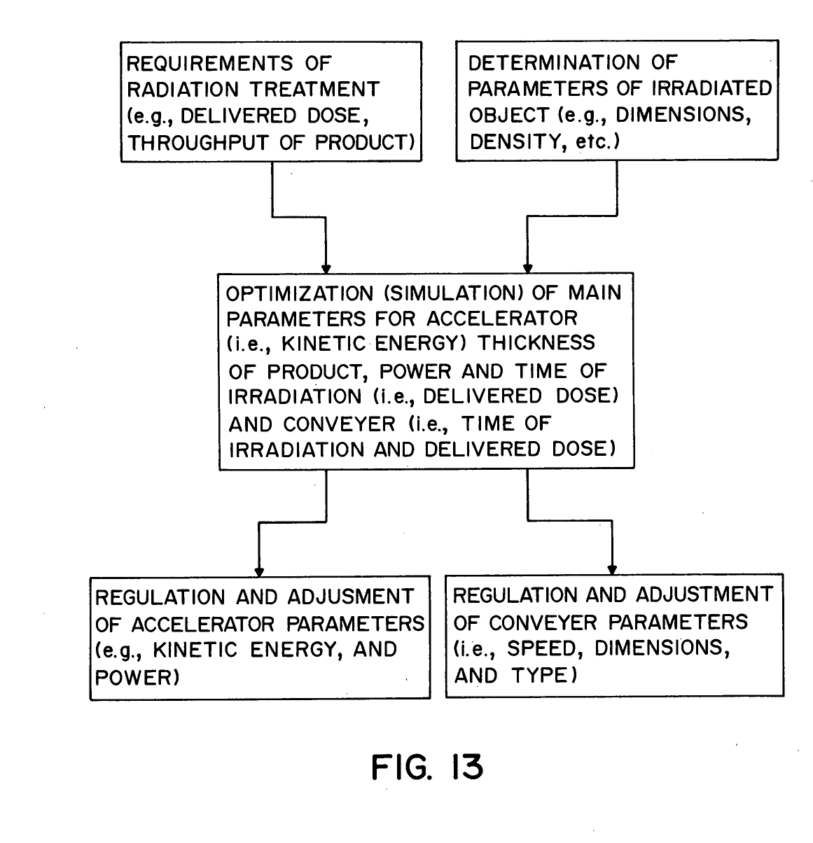

FIG. 13 shows a flow diagram for an operating control algorithm. Accelerator and conveyer parameters are regulated and adjusted for optimization in accordance with the requirements for radiation treatment and the determined object parameters. The object parameters are determined in the manner discussed above.

Referring now to FIG. 14, a sensor 80B′ according to an alternative embodiment is shown. In this embodiment, a current I3 of electrons in absorber plate 90 (produced by the collimated e-beam passing through absorber plate 90) is determined by measuring a voltage V3 across a resistor R3. As will be appreciated by those skilled in the art, current I1 can be determined by summing I2 and I3. Consequently, sensor 80A does not need to be used in connection with alternative sensor 80B′ in order to derive kinetic energy KE2 using the data tables expressing a relationship between I2/I1 and kinetic energy for a known absorber plate.

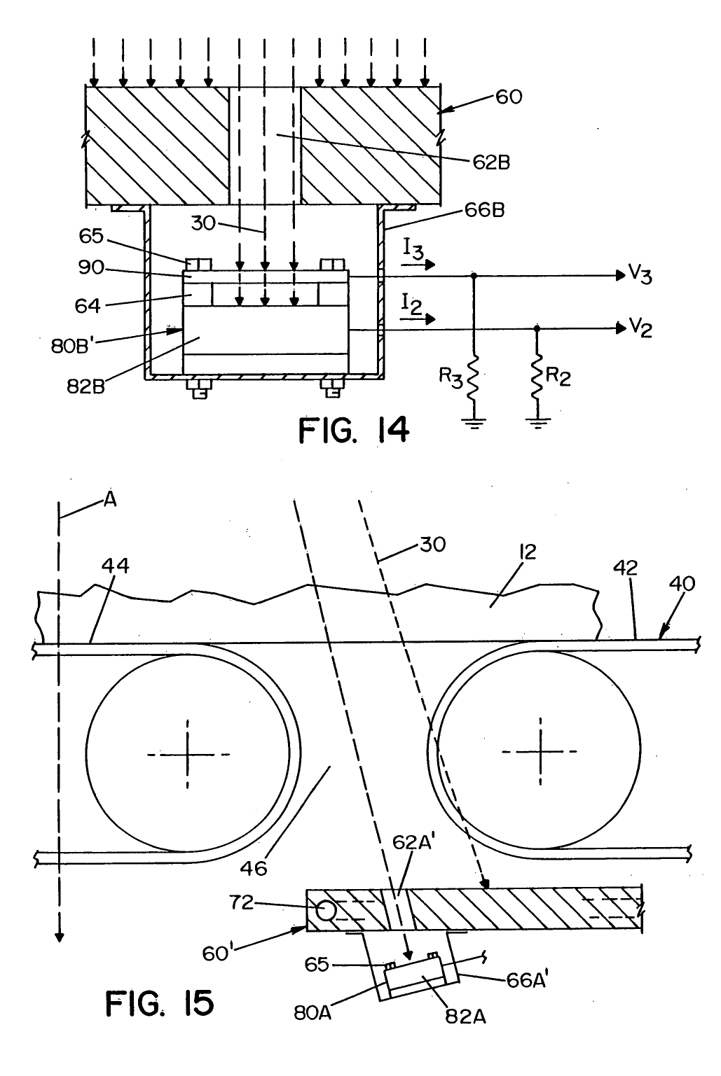

Referring now to FIG. 15, there is shown a collimator 60′, according to an alternative embodiment. Collimator 60′ includes a first aperture 62A′ and a second aperture (not shown). Each aperture has a central axis that is angled relative to the longitudinal axis of collimator 60′. The apertures are angled to align their central axis with the direction of the e-beam passing through gap 46. A housing 66A′ is dimensioned to align the central axis of sensors 80A with the central axis of first aperture 62A′. Likewise, a second housing is dimensioned to align the central axis of sensor 80B (not shown) with the central axis of the second aperture.

Set forth below is a table providing a definition of symbols used herein to describe computation of absorbed dose D, according to a preferred embodiment of the present invention.

| SYMBOL | DEFINITION |
|---|---|
| m | Unit mass of object |
| ρ | Density of object |
| V | Volume of object |
| A | Unit area of object |
| L | Thickness of unit mass object |
| νₛ | Beam scanning velocity |
| lₛ | Beam scanning length |
| tₛ | Beam scanning period |
| ƒ | Beam scanning frequency |
| Y | Length of unit area A in direction of conveyance |
| X | Length of unit area A in direction of beam scanning |
| ν_{c} | Conveyor speed |
| tₑ | Exposure time for unit area A per beam scan |
| Tₜ | Travel time for unit area A through beam |
| Nₛ | Total number of beam scans during travel time Tₜ |
| T | Total Beam exposure time |

Unit mass m of irradiated object 12 is determined for a selected a unit area A of object 12 by computing the product of (a) the volume V corresponding to the selected unit area A, and (b) the density p of object 12. In a preferred embodiment it is presumed that object 12 has a generally uniform density. It should be appreciated that the unit area may be any selected geometry. However, for the purpose of simplifying calculations a square or rectangular geometry is preferred.

Furthermore, while the entire area of object 12 could be selected as unit area A to determine an absorbed dose D based upon the entire mass of object 12 it is preferable to select a relatively small area of object 12 so that modifications can be made to operating parameters of irradiation system 10 during irradiation of object 12. In this regard, absorbed dose D can be continuously monitored as object 12 is moved through e-beam 30, and appropriate adjustments to operating parameters of irradiation system 10 can be made in a feedback loop. For instance, the measured absorbed dose D can be continuously compared to a threshold value during irradiation, and modifications can be made to one or more operating parameters of irradiation system 10 to effect an increase or decrease in the measured absorbed dose D.

Total beam exposure time T of unit mass m is determined by using: (1) the known values of the e-beam scanning parameters, i.e., e-beam scanning period tₛ (or scanning frequency f=1/tₛ), and e-beam scanning length lₛ (per scanning period); (2) the dimensions of the selected unit area A corresponding to unit mass m; and (3) conveyor speed ν_{c}.

Scanning period tₛ is typically computed from the scanning frequency f, where tₛ=1/f. Using the scanning period tₛ, and the beam scanning length lₛ, the beam scanning velocity νₛ is computed, where νₛ=(2)(lₛ)/tₛ. It should be appreciated that the beam scanning length is multiplied by 2 (as above), since the e-beam scans across the beam scanning length lₛ twice in a single scanning period tₛ.

Beam scanning length lₛ is measured as the sum of the distances of (1) the center axis to a first edge (corresponding to a maximum beam position to one side of the center axis), (2) the first edge to the center axis, (3) the center axis to a second edge (corresponding to a maximum beam position to the other side of the center axis), and (4) the second edge to the center axis.

Using the beam scanning velocity νₛ and the length X of the unit area in the scanning direction of the e-beam, the exposure time (i.e., tₑ) for the unit area A, per beam scan, is computed, where tₑ=X/νₛ. Therefore, the total number of electrons (Nₑₜ) in e-beam 30, per each beam scan, can be determined from the product of (1) the beam current I (coulombs/sec) and (2) the exposure time tₑ, divided by the elementary charge of an electron (e). Thus,
Nₑₜ=(I)(tₑ)/(e)=(I)(tₑ)/(1.6×10⁻¹⁹ coulomb).

The travel time Tₜ through the e-beam for unit area A is computed using length y of the unit area in the direction of conveyance, and conveyor speed ν_{c}, where Tₜ=Y/ν_{c}.

For the travel time Tₜ, the total number of beam scans Nₛ=(Tₜ)(f) is computed. Thus, the total beam exposure time T for unit area A is the product of (1) the total number of beam scans Nₛ, and (2) the exposure time tₑ per each beam scan (i.e., T=(Nₛ)(tₑ)).

Therefore, the total number of electrons (N_{eT}) for the total beam exposure time (T), can be determined from the product of (1) the beam current I (coulombs/sec) and (2) the total beam exposure time T, divided by the elementary charge of an electron (e). Thus,
N_{eT}=(I)(T)/(e)=(I)(T)/(1.6×10⁻¹⁹ coulomb).

It should be understood that in accordance with a preferred embodiment, the calculations for determining total beam exposure time T is based upon the following assumptions/approximations. First, it is assumed that the e-beam is basically a point which traces a line as it scans. In addition, it is assumed that unit area A receives the full output of e-beam 30 during total beam exposure time T.

As indicated above, kinetic energy KE1 and beam current I are parameters of the selected type of accelerator used to generate e-beam 30. Typically, KE1 is in the range of 0.2 MeV to 20 MeV (preferably 1 MeV to 10 MeV). Beam current I may range from 1 mA to 1 MA, depending upon the selected type of electron accelerator, as discussed above. As will be readily appreciated by those skilled in the art, once a value for beam current I is known, the number of electrons for any desired time period (e.g., tₑ and T) can be readily determined, since there are approximately 6.24×10¹⁸ electrons per coulomb.

Kinetic energy KE1 and beam current I of e-beam 30 (as output from horn 24) may be calibrated and verified using the apparatus of the present invention, but without the presence of object 12 on conveyer system 40. In this regard, measured kinetic energy KE2 should approximately equal KE1, since there is no object 12 to absorb kinetic energy. Similarly, current I can be determined by measuring the current I₁ associated with sensor 80A. Measured current I₁ should approximately equal current I in the absence of object 12.

As also discussed above, KE2 is determined empirically. In this regard, a relationship between (1) the ratio of: (a) the measured e-beam current I₂ after striking an absorber plate and (b) the measured e-beam current I₁ before striking the absorber plate, and (2) the kinetic energy KE2 is empirically derived.

It should be appreciated that the output beam of irradiation source 20 simultaneously produces thermal effects, shock waves and radiation-chemical effects that will deactivate biological and chemical warfare agents. Thermal effects are provided in adiabatic conditions. Biological warfare agents may be deactivated by destruction caused by the high temperatures, while chemical warfare agents may be deactivated by initiation of chemical reactions. In a preferred embodiment, thermal effect temperatures may range from about 100° C. to 2000° C. A temperature rise of about 200-500° C. is observed for each e-beam pulse.

The “shock waves” in the irradiated object deactivate biological warfare agents by mechanical destruction, and deactivate chemical agents by oscillations, an increase in the surface for activation of chemical reactions, and an increase in the efficiency of chemical reactions that lead to destruction of the chemical warfare agents.

Required absorbed dose values for some chemical and biological warfare agents are noted below:

| Warfare Agent | Absorbed Dose |
|---|---|
| Anthrax | 40-60 kGy |
| Escherichia coli | 2-3 kGy |
| Bacillus pumilus spores | 6-10 kGy |

The present invention will now be further described by way of the following examples:

### EXAMPLE 1

### Measurement and Monitoring of Absorbed Doses

Electron Beam Parameters

| | |
|---|---|
| Accelerator Type | “Rhodotron” RF CW |
| KE of emitted electrons (KE1) | 5 MeV |
| Beam Current (I) | 10 mA |
| Beam Repetition Rate (f) | 100 Hz (scans/sec) |
| Beam Scanning Length (lₛ) | 200 cm |

Object Parameters

| | |
|---|---|
| Unit Area (A) | 1 cm² |
| Geometry of Unit Area | Square |
| Length X | 1 cm |
| Length Y | 1 cm |
| Thickness (L) | 0.5 cm |
| Density (ρ) | 3 g/cm³ |

Conveyor Parameters

| | |
|---|---|
| Conveyor Speed (ν_{c}) | 1 cm/sec |

Sensor 80A Parameters

| | |
|---|---|
| Resistor R₁ | 100 Ohms |
| Measured V₁ | 0.7 Volts |

Sensor 80B Parameters

| | |
|---|---|
| Absorber Material | Aluminum |
| Density | 2.7 g/cm³ |
| Thickness | 500 μm |
| Resistor R₂ | 100 Ohm |
| Measured V₂ | 0.44 Volts |

### Computed Values

$$Unit mass m = ( ρ ) ( V ) = ( ρ ) ( A ) ( L ) = ( 3 g \text{/} {cm}^{2} ) ( 1 {cm}^{2} ) ( 0.5 cm ) = 1.25 g$$

$$\begin{matrix}Beam scanning velocity {v}_{s} = ( 2 ) ( {1}_{s} ) / t = ( 2 ) ( {1}_{s} ) / ( 1 / f ) \\ = ( 2 ) ( 200 cm ) \text{/} ( 0.01 sec ) = 4 \times {10}^{4} cm \text{/} s\end{matrix}$$

$$Exposure time per beam scan {t}_{e} = X / {v}_{s} = 1 cm \text{/} ( 4 \times {10}^{4} cm \text{/} s ) = 25 µsec$$

$$\begin{matrix}Travel time through beam {T}_{t} = ( length Y ) / ( conveyer speed {v}_{c} ) = 1 cm \text{/} ( 1 cm \text{/} s ) \\ = 1 sec\end{matrix}$$

$$\begin{matrix}For the travel time {T}_{t} , the total number of beams scans {N}_{s} = ( {T}_{t} ) ( f ) \\ = ( 1 sec ) ( 100 Hz ) \\ = 100 scans\end{matrix}$$

$$\begin{matrix}Total beam exposure time T ( for unit area A ) = ( {N}_{s} ) ( {t}_{e} ) \\ = ( 100 scans ) ( 25 µsec per scan ) \\ = 2.5 \times {10}^{- 3} sec \\ = 2.5 m sec of exposure time\end{matrix}$$

$${I}_{1} = {V}_{1} / {R}_{1} = 0.7 V \text{/} 100 Ω$$

$${I}_{2} = {V}_{2} / {R}_{2} = 0.44 V \text{/} 100 Ω$$

$${I}_{2} / {I}_{1} = 0.44 / 0.7 = .6286$$

KE2=0.7 MeV per electron, as derived from the table of FIG. 7, using I₂/I₁ for 500 μm aluminum foil.

KE1=5 MeV per electron
ΔKE=KE1−KE2=4.3 MeV per electron (i.e. energy absorbed by object per electron)

=10 mA

$$\begin{matrix}Absorbed Dose D = [ ( KE1 - KE2 ) ( I ) ( T ) ] / m \\ = [ ( 5 MeV - 0.7 MeV ) ( 10 mA ) ( 2.5 msec ) ] / 1.25 g \\ = [ ( 4.3 \times {10}^{6} eV ) ( 10 \times {10}^{- 3} C / s ) ( 2.5 \times {10}^{- 3} s ) ] / 1.25 \times {10}^{- 3} kg \\ = [ ( 4.3 \times {10}^{6} eV ) ( 25 \times {10}^{- 6} C ) ] 1.25 \times {10}^{- 3} kg \\ = [ ( 4.3 \times {10}^{6} eV ) ( 25 \times {10}^{- 6} C ) ( 6.24 \times {10}^{18} electrons / C ) ] / 6 \times {10}^{- 3} kg \\ = [ ( 4.3 \times {10}^{6} eV ) ( 1.56 \times {10}^{14} electrons ) ] / 1.25 \times {10}^{- 3} kg \\ = [ ( 6.708 \times {10}^{20} eV ) ( 1.602 \times {10}^{- 19} J / eV ) ] / 1.25 \times {10}^{- 3} kg \\ = 17.91 \times {10}^{3} J / kg = 71.64 kGray\end{matrix}$$

### EXAMPLE 2

### System for Treatment of Object

Required “absorbed dose”=60 kGy

Object Parameters Cybernetically Determined
by Parameter Acquisition System

| | |
|---|---|
| Unit Area (A) | 1216 cm² |
| Geometry of Unit Area | Rectangular (Box) |
| Length x | 32 cm |
| Length y | 38 cm |
| Thickness (L) | 3 cm |
| Mass (m) | 2432 g |
| Density (ρ) - paper | 0.5 g/cm³ |

Conveyor Parameters

| | |
|---|---|
| Conveyor Speed (ν_{c}) | 8.78 cm/sec |

Electron Beam Parameters

| | |
|---|---|
| Accelerator Type | CW Rhodotron |
| KE of emitted electrons (KE1) | 4.5 MeV (1 side irradiation) |
| Beam Power | 50 kW |
| Beam Current (I) | 10 mA |
| Beam Repetition Rate (ƒ) | 100 Hz |
| Beam Scanning Length (lₛ) | 200 cm |
| Factor of Beam | 0.6 |
| Throughput of product | 0.5 kg/sec |

It should be understood that the “factor of beam” is used for determining the total power of the accelerator.

### EXAMPLE 3

### System for Treatment of Object

Required “absorbed dose”=60 kGy

Object Parameters Cybernetically Determined
by Parameter Acquisition System

| | |
|---|---|
| Unit Area (A) | 1216 cm² |
| Geometry of Unit Area | Rectangular (Box) |
| Length x | 32 cm |
| Length y | 38 cm |
| Thickness (L) | 4 cm |
| Mass (m) | 2432 g |
| Density (ρ) - paper | 0.5 g/cm³ |
| Factor of Beam | 0.6 |
| Throughput of product | 0.5 kg/sec |

Conveyor Parameters

| | |
|---|---|
| Conveyor Speed (ν_{c}) | 13.4 cm/sec |

Electron Beam Parameters

| | |
|---|---|
| Accelerator Type | DC accelerator |
| KE of emitted electrons (KE1) | 3.0 MeV (1 side irradiation) |
| Beam Power | 50 kW |
| Beam Current (I) | 17 mA |
| Beam Repetition Rate (ƒ) | 100 Hz |
| Beam Scanning Length (lₛ) | 200 cm |

Other modifications and alterations will occur to others upon their reading and understanding of the specification. For instance, it is contemplated that the present invention may be suitably modified to irradiate an entire object while the object remains stationary under the e-beam. Irradiation commences in response to a sensor indicating proper positioning of the object relative to the location of an e-beam. In calculations of dose D, the travel time (Tₜ) through the beam is substituted with the time the e-beam is on. It is intended that all such modifications and alterations be included insofar as they come within the scope of the invention as claimed or the equivalents thereof.

1. An irradiation apparatus, comprising:
a parameter acquisition system for acquiring physical parameter data associated with an object to be irradiated;
an irradiation source for providing a beam, said beam selected from the group consisting of: e-beam and an X-ray beam;
a conveyor system for conveying an object to be irradiated through the radiation beam at a speed v, said conveyor system including an opening that allows a portion of the beam to pass through the object without striking the conveyor system; and
an absorbed dose sensing apparatus for providing data for determining an absorbed dose associated with the object.

2. An irradiation apparatus according to claim 1, wherein said absorbed dose sensing apparatus includes:
a collimator locatable to isolate portions of the beam that have passed through the opening, said collimator including at least first and second apertures for respectively providing first and second collimated beams; and
first and second sensors for providing data indicative of the kinetic energy of the electrons absorbed by the object, said first sensor receiving the first collimated beam, and the second aperture receiving the second collimated beam.

3. An irradiation apparatus as defined by claim 2, wherein said first and second sensors provide data for calculating the number of electrons in the beam.

4. An irradiation apparatus as defined in claim 2, wherein said first and second sensors respectively include a first electron collecting device and a second electron collecting device.

5. An irradiation apparatus as defined by claim 4, wherein said second sensor includes an absorber plate, said second collimated beam passing through the absorber plate before electron collection by said second electron collecting device.

6. An irradiation apparatus as defined by claim 5, wherein said first and second sensors respectively provide (a) first data to an associated processing system indicative of a first beam current, before the beam enters the absorber plate, and (b) second data indicative of a second beam current after the beam has passed through the absorber plate.

7. An irradiation apparatus as defined by claim 2, wherein said apparatus further comprises a processing system for determining the absorbed dose for the object using the first and second data respectively provided by said first and second sensors.

8. An irradiation apparatus as defined in claim 7, wherein in accordance with the absorbed dose determined by the processing system said processing system modifies at least one of: the speed v of said conveyor system, energy of said beam, a current of said beam, and a scanning velocity of said beam.

9. An irradiation apparatus as defined in claim 2, wherein said irradiation source scans said beam in at least one of:
a direction perpendicular to a direction of conveyance of the object,
a direction parallel to a direction of conveyance of the object, and
a direction at an angle to a direction of conveyance of the object.

10. An irradiation apparatus as defined in claim 9, wherein said irradiation source scans said beam through an arc of 30 degrees in a direction generally perpendicular to a direction of conveyance of said object.

11. An irradiation apparatus as defined in claim 1, wherein said a parameter acquisition system includes at least one of a imaging system and a pressure sensor.

12. An irradiation apparatus as defined in claim 1, wherein said beam provided by said irradiation source simultaneously produces thermal effects, shock waves and radiation-chemical effects for deactivation of biological and chemical warfare agents.

13. A method for irradiating an object, comprising:
acquiring physical parameter data associated with an object to be irradiated;
generating a beam, said beam selected from the group consisting of an e-beam and an X-ray beam;
moving an object through the beam on a conveyor system, said object traveling at a speed v; and
determining an absorbed dose D associated with the object.

14. A method according to claim 13, wherein said step of determining an absorbed dose associated with the object includes:
measuring a first current and a second current indicative of a kinetic energy absorbed by the object passing through the beam; and
determining said absorbed dose D for a selected area of the object in accordance with the kinetic energy absorbed by the object passing through the beam.

15. A method as defined by claim 13 wherein said method includes determining a number of electrons in the beam for a time of irradiation.

16. A method as defined by claim 13, wherein said method further comprises:
comparing the absorbed dose D to a threshold value; and
modifying at least one of: (1) a parameter of the irradiation source and (2) the speed v, in accordance with the comparison of the absorbed dose D to the threshold value.

17. A method as defined by claim 13, wherein said method further comprises:
displaying the absorbed dose D on an output device.

18. A method as defined by claim 13, wherein the step of determining an absorbed dose D includes:
determining a beam scanning velocity of the beam;
determining an exposure time of a unit area of the object per beam scan;
determining a travel time of the unit area through the beam;
determining a total number of beam scans during the travel time; and
determining a total exposure time of the unit area to the beam.

19. A method as defined by claim 18, wherein said method includes determining a number of electrons in the beam for a time of irradiation.

20. A method as defined by claim 13, wherein at least one portion of said beam is collimated after passing through said object to form at least one collimated beam.

21. A method as defined by claim 14, wherein said first current is a current associated with the beam after passing through the object, and said second current is a current associated with the beam after passing through the object and an absorber plate having known absorption characteristics.

22. A method as defined by claim 14, wherein said first current is a beam induced current in an absorber plate having known absorption characteristics associated with the beam after it has passed through the object; and said second current is a current associated with the beam after passing through the object and the absorber plate.

23. An irradiation system, comprising:
radiation generating means for generating a beam of known energy;
conveyance means for conveying an object through said beam at a speed v;
sensing means for providing data indicative of a kinetic energy absorbed by the object; and
processing means for receiving said data and determining a value for absorbed dose D of the object.

24. An irradiation system as defined by claim 23, wherein said sensing means provide data for calculating a number of electrons in the beam.

25. An irradiation system as defined by claim 23 wherein said processing means further comprises:
modification means for modifying at least one of: type of said beam, kinetic energy (KE) of an electron accelerator associated with the radiation generating means, current of said beam, pulse frequency, dimension of the cross-section of said beam, and said speed v of said conveyance means, in accordance with the predetermined absorbed dose D.

26. An irradiation system as defined by claim 25, wherein said modification means compares the determined absorbed dose D to a predetermined threshold value.

27. An irradiation system as defined by claim 26, wherein said absorbed dose D is continuously monitored, and said processing means modifies at least one of: type of said beam, kinetic energy (KE) of an electron accelerator associated with the radiation generating means, current of said beam, pulse frequency, dimension of the cross-section of said beam, and said speed v of said conveyance means, in response to the comparison of the determined absorbed dose D to the predetermined threshold value.
